(19) United States
(12) Patent Application Publication
(10) Pub. No.: US 2004/0208320 A1
(43) Pub. Date: Oct. 21, 2004

(54) Apparatus and method for secured facsimile transmission by use of a public key encryption algorithm

(76) Inventor: Steven H. Chen, San Jose, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/418,982

(22) Filed: Apr. 18, 2003

(51) Int. Cl. H04N 1/44

(52) U.S. Cl. 380/246

(57) ABSTRACT

In one embodiment of the invention, an apparatus for secured facsimile transmission, includes: a destination facsimile (fax) machine configured to receive a private key and generate a public key associated with the private key; and an originating fax machine configured to communicate with the destination facsimile via a network and to receive the public key, wherein the originating fax machine is configured to encrypt a fax data with the public key by use of an encryption algorithm and the destination fax machine configured to decrypt the fax data with the private key by use of a decryption algorithm. In another embodiment, a method for secured facsimile transmission, includes: providing a private key to a destination fax machine; generating a public key associated with the private key; using the public key in an originating fax machine to encrypt a fax data and generate an encrypted fax data; sending the encrypted fax data to the destination fax machine; and using the private key in the destination fax machine to decrypt the encrypted fax data.

### TECHNICAL FIELD

Embodiments of the present invention relate generally to facsimile machines. More particularly, embodiments of the present invention relate to secured facsimile transmissions by use of a public key encryption algorithm.

### BACKGROUND

Currently, all conventional facsimile (FAX) machines accept all incoming fax messages. Additionally, current fax transmission technologies transmit fax data that can be intercepted by unintended recipients and do not provide methods to provide security to the transmitted fax data. Furthermore, it is possible for a sender of the fax data to erroneously dial a “wrong” fax destination phone number, and this can permit an unintended recipient to receive the fax data transmission. Various problems, such as the unintended disclosure of confidential documents, may occur if transmitted fax data is faxed to an unintended recipient.

Therefore, the current technology for fax machines is limited in its capabilities and suffers from at least the above constraints and deficiencies.

### SUMMARY OF EMBODIMENTS OF THE INVENTION

In one embodiment of the invention, an apparatus for secured facsimile transmission, includes: a destination facsimile (fax) machine configured to receive a private key and generate a public key associated with the private key; and an originating fax machine configured to communicate with the destination facsimile via a network and to receive the public key, wherein the originating fax machine is configured to encrypt a fax data with the public key by use of an encryption algorithm and the destination fax machine configured to decrypt the fax data with the private key by use of a decryption algorithm.

The originating fax machine encrypts the fax data prior to transmission of the encrypted fax data across the network. The destination fax machine decrypts the encrypted fax data after transmission of the encrypted fax data across the network.

In another embodiment, a method for secured facsimile transmission, includes: providing a private key to a destination fax machine; generating a public key associated with the private key; using the public key in an originating fax machine to encrypt a fax data and generate an encrypted fax data; sending the encrypted fax data to the destination fax machine; and using the private key in the destination fax machine to decrypt the encrypted fax data.

In another embodiment, an article of manufacture, includes: a machine-readable medium having stored thereon instructions to: generate a public key associated with a private key; use the public key in an originating fax machine to encrypt a fax data and generate an encrypted fax data; send the encrypted fax data to the destination fax machine; and use the private key in the destination fax machine to decrypt the encrypted fax data.

These and other features of an embodiment of the present invention will be readily apparent to persons of ordinary skill in the art upon reading the entirety of this disclosure, which includes the accompanying drawings and claims.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram of an apparatus (system) in accordance with an embodiment of the invention.

FIG. 2 is a block diagram illustrating additional details of the apparatus of FIG. 1, in accordance with an embodiment of the invention.

FIG. 3 is a flowchart of a method in accordance with another embodiment of the invention.

### DETAILED DESCRIPTION OF PREFERRED EMBODIMENTS

In the description herein, numerous specific details are provided, such as examples of components and/or methods, to provide a thorough understanding of embodiments of the invention. One skilled in the relevant art will recognize, however, that an embodiment of the invention can be practiced without one or more of the specific details, or with other apparatus, systems, methods, components, materials, parts, and/or the like. In other instances, well-known structures, materials, or operations are not shown or described in detail to avoid obscuring aspects of embodiments the invention.

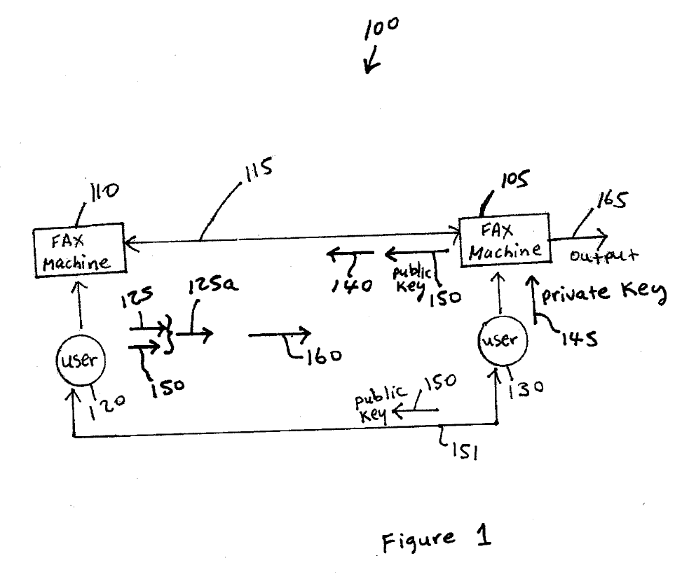

FIG. 1 is a block diagram of an apparatus (or system) 100 in accordance with an embodiment of the invention. The apparatus 100 includes a receiving (destination) facsimile (fax) machine 105 and a sending (transmitting) fax machine 110, where the fax machines 105 and 110 can communicate with each other via a network 115. The network 115 may be any suitable telecommunications network that permits the fax machines 105 and 110 to communicate with each other.

An embodiment of the invention provides the following method for secured fax transmission when a sending user 120 of the sending fax machine 110 sends a transmission of fax data 125 across the network 115 to a destination user 130 of the destination fax machine 105. As described in detail below, the fax data 125 will be encrypted in order to provide a secured transmission of the fax data 125 from the sending fax machine 110 to the destination fax machine 105 via network 115.

In an embodiment of the invention, the user 130 of the destination fax machine 105 provides a private key 145 that is input into the destination fax machine 105 and that will be described further below. The private key 145 can be can be, for example, a one-digit, two-digit, or three-digit numerical text (e.g., code “123” or another code with other numerical text value and digit length) that can be input into the destination fax machine 105. Of course, the private key 145 can have numerical text of other digit lengths and values (e.g., code “456710”). The destination fax machine 105 then generates a public key 150 that is associated with the private key 145. The public key 150 is generated by use of known public key cryptography techniques. Public key cryptography techniques are further described in, for example, Simon Garfinkel, “PGP: Pretty Good Privacy”, 1^{st} edition, page 50 (published by O'Reilly & Associates, Inc., 1995). The public key 150 can be, for example, a multi-digit numerical text (e.g., code “567890” or another code with other numerical text value and digit length).

When the user 130 of the destination fax machine 105 wishes to receive a secured fax transmission from the user 120 of the sending fax machine 110, the following method is used, in accordance with an embodiment of the invention.

The destination user 130 can contact the sending user 120 via another communication medium 151 (e.g., by use of an e-mail message via the Internet, by calling via a telephone network, by sending a letter via the postal network, by personally providing the public key 150 by a sticky note, or other methods by use of a communication medium 151). Of course, the destination user 130 can also use the network 115 to provide the public key 150 to the sending user 120, where the destination user 130 can provide the public key 150 by phone, e-mail, or other suitable methods of communication across the network 115. The destination user 130 can then pass the code of the public key 150 to the sending user 120 by the above methods. The destination user 150 can then enter the code of the public key 150 into the sending fax machine 110. The public key 150 is then stored in memory of the standard fax hardware of the originating fax machine 110 and is used to encrypt the fax data 125 prior to transmission via network 115 to the destination fax machine 105.

Alternatively as an option, the destination fax machine 105 may first establish contact with the sending fax machine 110 by transmitting a phone number 140 across the network 115, where the phone number 140 is the phone number of the sending fax machine 110 and where the phone number 140 establishes contact between the fax machine 110 and fax machine 105. The phone number 140 establishes contact between the fax machines 110 and 105 by use of standard call routing methods that are known to those skilled in the art. After contact has been established between the destination fax machine 105 and the originating fax machine 110, the destination fax machine 105 then sends the public key 150 to the originating fax machine 110. The public key 150 is then stored in memory of the standard fax hardware of the originating fax machine 110.

After the originating fax machine 110 obtains the public key 150, the user 120 can send a secured fax transmission of fax data 125 from the originating fax machine 110 to the destination fax machine 105. The sending fax machine 110 first establishes contact with the destination fax machine 105 by transmitting a phone number 160 across the network 115, where the phone number 160 is the phone number of the destination fax machine 110 and where the phone number 160 establishes contact between the fax machine 110 and fax machine 105. The phone number 160 establishes contact between the fax machines 110 and 105 by use of standard call routing methods that are known to those skilled in the art.

After contact has been established between the calling fax machine 110 and the destination fax machine 105, the calling fax machine 110 encrypts the fax data 125 with the public key 150 by use of a standard encryption algorithm. The resulting encrypted fax data 125a is then transmitted by the calling fax machine 110 via network 115 to the destination fax machine 105.

The destination fax machine 105 then receives the encrypted fax data 125a and decrypts the encrypted fax data 125a with the private key 145 by use of a standard decryption algorithm. As a result of the decryption algorithm, the destination fax machine 105 is able to obtain the original fax data 125 from the sending fax machine 110.

The destination fax machine 105 will then generate, for example, a printed output 165 of the fax data 125 after the encrypted fax data 125 is decrypted. It is noted that the printed output 165 is not limited to a printed paper output that contains a text or/and image that represents the fax data 125. The printed output 165 may alternatively be, for example, a text or/and image (that represents the fax data 125) as displayed on a printer screen.

Therefore, the receiving user 130 will not be able to view a fax output 165 (that is associated with the fax data 125) unless the receiving user 130 has the private key 145 associated with the public key 150 that had encrypted the fax transmission data 125. Thus, an embodiment of the invention advantageously provides an apparatus 100 that permits secured fax transmission from a sending fax machine 110 to a destination fax machine 105 by use of standard public key and private key encryption and decryption algorithms. In order to maximize security, the destination fax machine 105 may require the destination user 130 to enter the code of the private key 145 into the destination fax machine 105 before decryption is performed on the received encrypted signal 160.

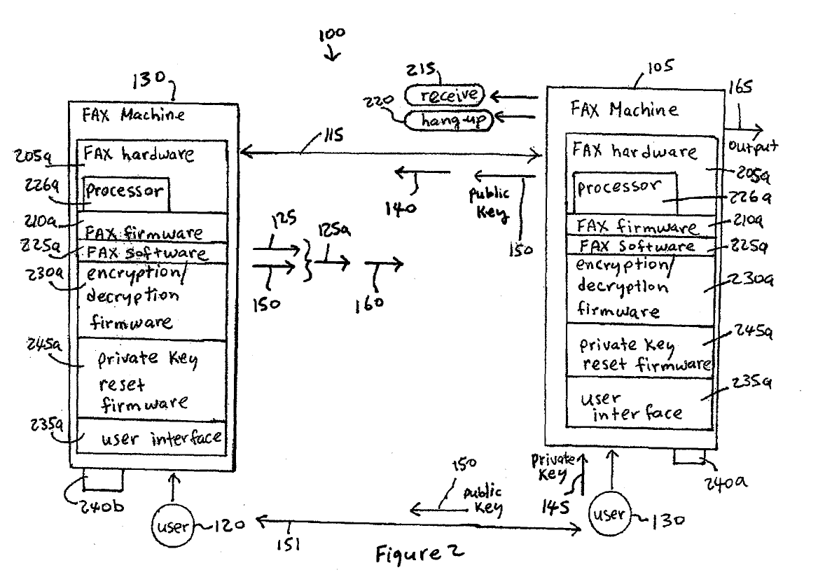

FIG. 2 is a block diagram illustrating additional details of the apparatus 100 of FIG. 1, in accordance with an embodiment of the invention. In an embodiment, the destination fax machine 105 includes a standard fax hardware 205a and standard fax firmware 210a. The fax hardware 205a and fax firmware 210a perform standard fax machine functions such as, for example, a receiving function 215 to permit a fax transmission signal to be received by the destination fax machine 105 and a hang-up function 220 to permit the destination fax machine 105 to block or reject a fax transmission signal. The fax hardware 205a and fax firmware 210a can also accept the destination phone number 160 that is dialed from the transmitting fax machine 110 so that connectivity is established between the transmitting fax machine 110 and destination fax machine 105, and to also send and receive the fax transmission signals across the network 115. The fax hardware 205a and fax firmware 210a can also generate a printout 165 of any fax data 125 that is received by the fax machine 105.

The firmware 210a is typically stored in a memory that is part of the standard fax hardware 205a. The fax hardware 205a and fax firmware 210a may perform other known functions in a fax machine. As known to those skilled in the art, firmware is programming code that is inserted into programmable read-only memory (programmable ROM) or is stored in a ROM, thus becoming a permanent part of a computing device. Firmware is created and tested like software (using microcode simulation). When ready, firmware can be distributed like other software and, using a user interface, installed in the programmable read-only memory by a user. Firmware is sometimes distributed for printers, modems, and other computer devices.

The destination fax machine 105 may also include standard fax software 225a that provides other standard fax machine functions. The software 225a is also typically stored in memory that is part of the standard fax hardware 205a. Other standard components and/or software in the programmable fax machine 105 have been omitted in FIG. 2 for purposes of clarity and for purposes of focusing on the functionalities of embodiments of the invention.

The destination fax machine 105 also includes a processor 226a that executes various firmware and software in the destination fax machine 105.

It is noted that the originating fax machine 110 also includes similar hardware, firmware, and software that are in the destination fax machine 105. For example, the originating fax machine 110 includes the standard fax hardware 205b, standard fax firmware 210b, processor 226a, encryption/decryption firmware 230b, and other components or firmware/software as shown in FIG. 2.

In an embodiment, the destination fax machine 105 includes encryption/decryption firmware 230a that is stored, for example, in memory that is part of the standard fax hardware 205a. The user 130 may be prompted by a user interface firmware 235a to program (enter) a code of the private key 145 (also referred herein as “private key”) that will be used to decrypt an encrypted fax transmission from an originating fax machine 110. In order to maximize security, the destination user 130 may also be prompted by the user interface firmware 235a to enter the code of the private key 145 into the fax interface component 240a before decryption of the encrypted message 160 is performed by the encryption/decryption firmware 230a.

The user 130 can program the private key 145 by use of the fax interface component 240a which can be, for example, buttons, a touch-screen, or other suitable selection mechanisms or interfaces that permit the user 130 to enter numerical text that will form the private key 145.

As an option, a private key reset firmware 245a permits the user 130 to reset the value of the private key 145. Typically, the private key reset firmware 245a can erase the private key 145 that has been programmed into the encryption/decryption firmware 230a and can permit the user 130 to select a new code value of the private key 145 to enter via interface component 240a and to program into the encryption/decryption firmware 230a, where the new private key 145 is used to decrypt an encrypted fax transmission that is received via network 115.

It is noted that it is within the scope of embodiments of the invention that at least some of the encryption/decryption firmware 230a, user interface firmware 235a, and private key reset firmware 245a can be combined into a single firmware that provides multiple functionalities as described above.

An example operation of the apparatus 100 is now described, in accordance with an embodiment of the invention. The user 130 of the destination fax machine 105 provides a private key 145 that can be entered via the interface component 240a. The user interface firmware 235a transmits the private key 145 to the encryption/decryption firmware 230a. The encryption/decryption firmware 230a then generates a public key 150 that is associated with the private key 145 by use of standard public key cryptography techniques. The processor 226a executes the encryption/decryption firmware 230a to perform the public key 150 generation, decryption operation, and other operations of the firmware 230a as described herein.

When the user 130 of the destination fax machine 105 wishes to receive a secured fax transmission from the user 120 of the sending fax machine 110, the following method is used, in accordance with an embodiment of the invention.

The destination user 130 can contact the sending user 120 via another communication medium 151 (e.g., by use of an e-mail message via the Internet, by calling via a telephone network, by sending a letter via the postal network, by personally providing the public key 150 by a sticky note, or other methods by use of a communication medium 151). The destination user 130 can also use the network 115 to provide the public key 150 to the sending user 120, where the destination user 130 can provide the public key 150 by phone, e-mail, or other suitable methods of communication across the network 115. The destination user 130 can then pass the code of the public key 150 to the sending user 120 by the above methods. The destination user 150 can then enter the code of the public key 150 into the sending fax machine 110. The public key 150 is then stored in memory of the standard fax hardware 205a of the originating fax machine 110 and is used to encrypt the fax data 125 prior to transmission via network 115 to the destination fax machine 105.

Alternatively as an option, the standard fax hardware 205a and standard fax firmware 210a in the destination fax machine 105 may first establish contact with the sending fax machine 110 by transmitting a phone number 140 across the network 115, where the phone number 140 is the phone number of the sending fax machine 110 and where the phone number 140 establishes contact between the fax machine 110 and fax machine 105. The phone number 140 establishes contact between the fax machines 110 and 105 by use of standard call routing methods that are known to those skilled in the art. The standard fax hardware 205b and standard fax firmware 210b in the originating fax machine 110 permits the originating fax machine 110 to communicate with the destination fax machine 105. After contact has been established between the destination fax machine 105 and the originating fax machine 110, the standard fax hardware 205a and standard fax firmware 210a in destination fax machine 105 then sends the public key 150 to the originating fax machine 110. The public key 150 is received by the standard fax hardware 205b and standard fax firmware 210b in the originating fax machine 110, and the encryption/decryption firmware 230b then stores the public key 150 in memory in the standard fax hardware 205b of the originating fax machine 110. The processor 226b executes the encryption/decryption firmware 230b to perform the encryption operation and other operations of the firmware 230b as described herein.

Subsequently, the user 120 can send a secured fax transmission of fax data 125 from the originating fax machine 110 to the destination fax machine 105. The sending fax machine 110 first establishes contact with the destination fax machine 105 by transmitting a phone number 160 across the network 115, where the phone number 160 is the phone number of the destination fax machine 110 and where the phone number 160 establishes contact between the fax machine 110 and fax machine 105. The standard fax hardware 205b and standard fax firmware 210b in the calling fax machine 110 transmit the phone number 160 across the network 115.

After contact has been established between the calling fax machine 110 and the destination fax machine 105, the encryption/decryption firmware 230b in the calling fax machine 110 encrypts the fax data 125 with the public key 150 by use of a standard encryption algorithm. The resulting encrypted fax data 125a is then transmitted by the standard fax hardware 205b and standard fax firmware 210b via network 115 to the destination fax machine 105.

The standard fax hardware 205a and standard fax firmware 210a in the destination fax machine 105 then receives the encrypted fax data 125a. The encryption/decryption firmware 230a in the destination fax machine 105 then decrypts the encrypted fax data 125a with the private key 145 by use of a standard decryption algorithm. As a result of the decryption algorithm, the destination fax machine 105 is able to obtain the original fax data 125 from the sending fax machine 110.

The standard fax hardware 205a and standard fax firmware 210a in the destination fax machine 105 will then generate, for example, a printed output 165 of the fax data 125.

As an option, the encryption/decryption firmware 230a in the destination fax machine 105 (and/or the encryption/decryption firmware 230b in the originating fax machine 105 when it will be a receiving device) will generate a random key value for each public key 150 that is associated with a private key 145. This feature provides increased security in fax transmissions because the public key 150 value is randomized. Alternatively, the encryption/decryption firmware 230a will generate the same key value for each public key 150 that is associated with a private key 145. This alternative feature provides sufficient security coverage for fax transmissions because the fax sender still has the protection of encryption for his/her transmission of a fax data 125. As another alternative, the encryption/decryption firmware 230a will require a unique public key & private key pair for every secured transmission to be performed.

The encryption/decryption firmware 230a, private key reset firmware 245a, and user interface firmware 235a can be set to perform the above described functions by use of standard programming techniques.

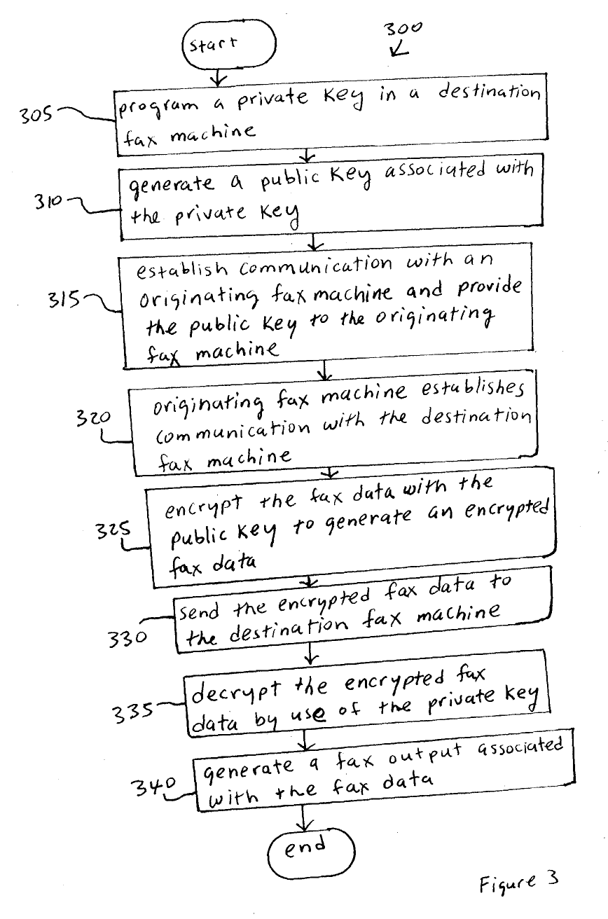

FIG. 3 is a flowchart of a method 300 in accordance with another embodiment of the invention. Initially, the user enters (programs) (305) a private key 145 in a destination fax machine. As an example, the private key 145 can be a numerical text with an X-number of digits, where X is any suitable integer value). A public key 150 associated with the private key 145 is then generated (310) by the destination fax machine. The destination user then provides the public key to the sending user, as shown in step (320). Alternatively as an option, the destination fax machine then establishes communication with an originating fax machine and provides the public key 150 to the originating fax machine, as also shown in step (315). Subsequently, the originating fax machine then establishes (320) communication with the destination fax machine, if a secured fax transmission is desired from the originating fax machine to the destination fax machine. The originating fax machine encrypts (325) the fax data by use of the public key 150 to generate an encrypted fax data. The originating fax machine then sends (330) the encrypted fax data to the destination fax machine. The destination fax machine then decrypts (335) the encrypted fax data by use of the private key 145. The destination fax machine can then generate (340) a fax output associated with the fax data. The fax output may be, for example, a printout with text and/or images that are associated with the fax data.

The various engines or modules discussed herein may be, for example, software, firmware, commands, data files, programs, code, instructions, or the like, and may also include suitable mechanisms.

Reference throughout this specification to “one embodiment”, “an embodiment”, or “a specific embodiment” means that a particular feature, structure, or characteristic described in connection with the embodiment is included in at least one embodiment of the present invention. Thus, the appearances of the phrases “in one embodiment”, “in an embodiment”, or “in a specific embodiment” in various places throughout this specification are not necessarily all referring to the same embodiment. Furthermore, the particular features, structures, or characteristics may be combined in any suitable manner in one or more embodiments.

Other variations and modifications of the above-described embodiments and methods are possible in light of the foregoing teaching.

Further, at least some of the components of an embodiment of the invention may be implemented by using a programmed general purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application.

It is also within the scope of the present invention to implement a program or code that can be stored in a machine-readable medium to permit a computer to perform any of the methods described above.

Additionally, the signal arrows in the drawings/Figures are considered as exemplary and are not limiting, unless otherwise specifically noted. Furthermore, the term “or” as used in this disclosure is generally intended to mean “and/or” unless otherwise indicated. Combinations of components or actions will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. An apparatus for secured facsimile transmission, the apparatus comprising:
a destination facsimile (fax) machine configured to receive a private key and generate a public key associated with the private key; and
an originating fax machine configured to communicate with the destination facsimile via a network and to receive the public key, wherein the originating fax machine is configured to encrypt a fax data with the public key by use of an encryption algorithm and the destination fax machine configured to decrypt the fax data with the private key by use of a decryption algorithm.

2. The apparatus of claim 1, wherein the originating fax machine encrypts the fax data prior to transmission of the encrypted fax data across the network.

3. The apparatus of claim 1, wherein the destination fax machine decrypts the encrypted fax data after transmission of the encrypted fax data across the network.

4. The apparatus of claim 1, wherein the fax data is encrypted to provide secured transmission of the fax data across the network.

5. The apparatus of claim 1, wherein the public key is provided by a destination user of the destination fax machine to a sending user of the originating fax machine.

6. The apparatus of claim 1, wherein the public key is provided by the destination fax machine to the originating fax machine.

7. The apparatus of claim 1, the destination fax machine generates a random value for each public key that is associated with a private key.

8. The apparatus of claim 1, the destination fax machine generates a same value for each public key that is associated with a private key.

9. A method for secured facsimile transmission, the method comprising:
providing a private key to a destination fax machine; generating a public key associated with the private key;
using the public key in an originating fax machine to encrypt a fax data and generate an encrypted fax data;
sending the encrypted fax data to the destination fax machine; and
using the private key in the destination fax machine to decrypt the encrypted fax data.

10. The method of claim 9, wherein the fax data is encrypted to provide secured transmission of the fax data across the network.

11. The method of claim 9, wherein the public key is provided by a destination user of the destination fax machine to a sending user of the originating fax machine.

12. The method of claim 9, wherein the public key is provided by the destination fax machine to the originating fax machine.

13. The method of claim 9, wherein the action of generating the public key comprises:
generating a random value for each public key that is associated with a private key.

14. The method of claim 9, wherein the action of generating the public key comprises:
generating a same value for each public key that is associated with a private key.

15. The method of claim 9, further comprising:
requiring a destination user of the destination fax machine to provide the private key to the destination fax machine prior to decryption of the encrypted fax message.

16. An apparatus for secured facsimile transmission, the apparatus comprising:
means for generating a public key associated with a private key;
means for using the public key in an originating fax machine to encrypt a fax data and generate an encrypted fax data;
means for sending the encrypted fax data to the destination fax machine; and
means for using the private key in the destination fax machine to decrypt the encrypted fax data.

17. The apparatus of claim 16, wherein the fax data is encrypted to provide secured transmission of the fax data across the network.

18. The apparatus of claim 16, wherein the public key is provided by a destination user of the destination fax machine to a sending user of the originating fax machine.

19. The apparatus of claim 16, wherein the public key is provided by the destination fax machine to the originating fax machine.

20. An article of manufacture, comprising:
a machine-readable medium having stored thereon instructions to:
generate a public key associated with a private key;
use the public key in an originating fax machine to encrypt a fax data and generate an encrypted fax data;
send the encrypted fax data to the destination fax machine; and
use the private key in the destination fax machine to decrypt the encrypted fax data.
